(19) United States
(12) Patent Application Publication
(10) Pub. No.: US 2023/0016700 A1
(43) Pub. Date: Jan. 19, 2023

(54) COMPOSITIONS, METHODS, AND SYSTEMS FOR CAPTURING CARBON DIOXIDE FROM A GAS STREAM

(71) Applicant: SHELL OIL COMPANY, HOUSTON, TX (US)

(72) Inventors: Stefan Henricus Angelina Maria LEENDERS, Amsterdam (NL); Elske Belia ZEGEREN, Amsterdam (NL); Ronald OUDWATER, Amsterdam (NL)

(21) Appl. No.: 17/781,519

(22) PCT Filed: Dec. 24, 2020
(86) PCT No.: PCT/EP2020/087865

§ 371 Date: Jun. 1, 2022

Related U.S. Application Data
(60) Provisional application No. 62/954,970, filed on Dec. 30, 2019.

(51) Int. Cl. B01J 20/26; B01D 53/08; B01J 20/28; B01J 20/30

(52) U.S. Cl. CPC B01J 20/265; B01D 53/08; B01J 20/28071; B01J 20/28073; B01J 20/28059; B01J 20/3085; B01J 20/28011; B01J 20/261; B01D 2253/202; B01D 2257/504; B01D 2259/40098; B01D 2253/311; B01D 2253/306; B01J 2220/56

(57) ABSTRACT

The present disclosure relates to a solid adsorbent for capturing carbon dioxide (CO₂) from a gas stream comprising CO₂, the solid adsorbent comprising an amine covalently bonded to a polymer resin (e.g., a polystyrene resin), wherein the solid adsorbent has a CO₂ uptake capacity of greater than about 7 wt. % at a temperature of about 40° C., and wherein the solid adsorbent has a CO₂ uptake capacity of less than about 1.5 wt. % at a temperature of about 100° C., as measured when the gas stream further comprises a concentration of the CO₂ of about 4 vol. %, by volume of the gas stream.

### FIELD OF THE DISCLOSURE

The present disclosure relates, in some embodiments, to capturing carbon dioxide (CO₂) from a gas stream, such as a flue gas stream, using solid adsorbent particles.

### BACKGROUND OF THE DISCLOSURE

Carbon dioxide emissions (CO₂) produced by fuel consumption is a major concern for modern society as it is the primary greenhouse gas affecting the Earth's atmosphere. Even though post-combustion capture of CO₂ is now a mature technology, separating CO₂ from flue gases has many issues that require further development.

Some CO₂ adsorption technologies use liquid amines to adsorb CO₂. However, this approach requires high regeneration energy during the water evaporation process, high fouling rates of process equipment, and an uphill battle with equipment corrosion. Alternatively, solid sorbents may be used that can reduce the heat of regeneration due to their low heat capacities for CO₂ capture. Solid sorbent technologies employ a solid support (e.g., polymer substrate, silica, activated carbon) to support hydrophilic molecules—such as amines—that capture CO₂ from flue gases.

Current solid sorbent CO₂ capture technology uses a temperature swing adsorption approach in which a sorbent adsorbs CO₂ from a flue gas at a low temperature. The CO₂ rich sorbent is stripped with stream at an elevated temperature and the lean sorbent is recycled again in the process. Existing technologies include a large temperature differential between the effective adsorption and desorption temperatures. The large temperature differential severely increases the cost of the processes as obtaining and maintaining higher temperatures is both energy and resource intensive. In general, higher temperatures may lead to chemical degradation of the solid sorbent, thereby decreasing system efficiency while increasing cost of handling the waste product and replacing the degraded solid sorbent.

### SUMMARY

Accordingly, there is a need for improved compositions, methods, and systems for capturing carbon dioxide from a gas stream. The present disclosure describes improved solid adsorbents for capturing CO₂ from a gas stream, including adsorbents having an improved temperature differential between when the solid adsorbent adsorbs and desorbs CO₂. The present disclosure further describes methods and systems for using an improved solid adsorbents.

A solid adsorbent for capturing CO₂ from a gas stream having CO₂ includes an amine covalently bonded to a polymer resin. In the present Application, various amines and polymer resins are used to maximize a CO₂ uptake capacity at adsorption temperatures, minimize regeneration temperatures, and minimize CO₂ uptake capacity at regeneration temperatures. A disclosed solid adsorbent may have, for example, a CO₂ uptake capacity of greater than about 7 wt. % at a temperature of about 40° C. and a CO₂ uptake capacity of less than about 1.5 wt. % at a temperature of about 100° C., when a gas stream further comprises a concentration of the CO₂ of about 4 vol. %, by volume of the gas stream. In some embodiments, A disclosed solid adsorbent may have, for example, a CO₂ uptake capacity of greater than about 0.07 g/g solid adsorbent at a temperature of about 40° C. and a CO₂ uptake capacity of less than about 0.015 g/g solid adsorbent at a temperature of about 100° C., when a gas stream further comprises a concentration of the CO₂ of about 4 vol. %, by volume of the gas stream. This may desirably provide for a high cyclic loading in which a solid adsorbent may adsorb and desorb CO₂ from a gas stream. A solid adsorbent may be used in disclosed processes and systems.

A solid adsorbent may be used in a system for capturing CO₂ from a gas stream having CO₂. In some embodiments, a system includes an adsorption zone that is connected to a desorption zone through a transfer line and a recycle line. An adsorption zone includes a gas stream inlet for receiving a gas stream and an adsorbent bed having a solid adsorbent. In an adsorption zone, a gas stream may be combined with a solid adsorbent so that the solid adsorbent can adsorb CO₂ from the gas stream to form a CO₂-enriched solid adsorbent. A solid adsorbent may adsorb from about 80% to about 99% of CO₂ from a gas stream. For example, a solid adsorbent may adsorb about 80% of CO₂, or about 85% of CO₂, or about 90% of CO₂, or about 95% of CO₂, or about 99% of CO₂, where about includes plus or minus 5% CO₂. An adsorption zone includes a flue gas outlet for releasing a gas that has had substantially all CO₂ removed from it (e.g., a gas having less than about 0.5% CO₂). A desorption zone may be configured to receive a CO₂-enriched solid adsorbent from the adsorption zone through a transfer line so that a CO₂ may be desorbed from the solid adsorbent to form a CO₂-depleted solid adsorbent. A disclosed system may be used to perform a process for capturing CO₂ from a gas stream having CO₂.

According to some embodiments, a process for capturing CO₂ from a gas stream comprising CO₂ includes an adsorption and desorption step. To adsorb CO₂ from a gas stream, a process includes a step of contacting the gas stream with a solid adsorbent in an adsorption zone to form a CO₂-enriched solid adsorbent. To release a CO₂ from a CO₂-enriched solid adsorbent, a process includes a step of heating a CO₂-enriched solid adsorbent in a desorption zone to a temperature of greater than about 90° C. to desorb the CO₂ from the CO₂-enriched solid adsorbent to form a desorbed CO₂ and a CO₂-depleted solid adsorbent. A desorbed CO₂ may be collected in another tank.

### BRIEF DESCRIPTION OF THE DRAWINGS

Some embodiments of the disclosure may be understood by referring, in part, to the present disclosure and the accompanying drawings, wherein:

FIG. 1 illustrates a side perspective of a system for capturing carbon dioxide from a gas stream including an adsorption zone and a desorption zone that both include a solid adsorbent, according to a specific example embodiment of the disclosure;

FIG. 2 is a plot of the carbon dioxide uptake capacity vs temperature for solid adsorbents having various ethylene linkers, according to a specific example embodiments of the disclosure;

FIG. 3 is a bar graph comparing carbon dioxide uptake capacity, dry nitrogen content, and nitrogen utilization for solid adsorbents having various ethylene linkers, according to a specific example embodiments of the disclosure;

FIG. 4 is a plot of the carbon dioxide uptake capacity vs temperature for solid adsorbents functionalized with diamines having two to six methylene units, according to a specific example embodiments of the disclosure;

FIG. 5 is a bar graph comparing carbon dioxide uptake capacity, dry nitrogen content, and nitrogen utilization for solid adsorbents functionalized with diamines having two to six methylene units, according to a specific example embodiments of the disclosure;

FIG. 6 is a plot of the carbon dioxide uptake capacity vs CO₂ pressure for Purolite A110 at 50° C. and a solid adsorbent functionalized with ethylene diamine at 50° C., according to a specific example embodiments of the disclosure;

FIG. 7 is a plot of the carbon dioxide uptake capacity vs CO₂ pressure for Purolite A110 at 120° C. and a solid adsorbent functionalized with ethylene diamine at 110° C. and at 120° C., according to a specific example embodiments of the disclosure;

FIG. 8 is an isotherm plot of the carbon dioxide uptake capacity vs CO₂ pressure for a solid adsorbent functionalized with ethylenediamine at 50° C., 60° C., 70° C., 80° C., 110° C., and 120° C., according to a specific example embodiments of the disclosure;

FIG. 9 is an isotherm plot of the carbon dioxide uptake capacity vs CO₂ pressure for a solid adsorbent functionalized with 1,3-diaminopropane at 50° C., 60° C., 70° C., 80° C., 110° C., and 120° C., according to a specific example embodiments of the disclosure;

FIG. 10 is an isotherm plot of the carbon dioxide uptake capacity vs CO₂ pressure for a solid adsorbent functionalized with 1,4-diaminobutane at 50° C., 60° C., 70° C., 80° C., 110° C., and 120° C., according to a specific example embodiments of the disclosure;

FIG. 11 is an isotherm plot comparing isotherms for a solid adsorbent functionalized with ethylenediamine, 1,3-diaminopropane, or 1,4-diaminobutane at 50° C. and 120° C., according to a specific example embodiments of the disclosure;

FIG. 12 is an isotherm plot comparing isotherms for a solid adsorbent functionalized with ethylenediamine, 1,3-diaminopropane, or 1,4-diaminobutane at 60° C. and 110° C., according to a specific example embodiments of the disclosure;

FIG. 13 is an isotherm plot comparing isotherms for a solid adsorbent functionalized with ethylenediamine, 1,3-diaminopropane, or 1,4-diaminobutane at 70° C., according to a specific example embodiments of the disclosure;

FIG. 14 is an isotherm plot comparing isotherms for a solid adsorbent functionalized with ethylenediamine, 1,3-diaminopropane, or 1,4-diaminobutane at 80° C., according to a specific example embodiments of the disclosure; and

FIG. 15 is a plot of dV/dW intrusion based on mercury of nitrogen intrusion of the disclosure; and vs pore diameter, according to a specific example embodiments.

### DETAILED DESCRIPTION

The present disclosure relates, in some embodiments, to a solid adsorbent for capturing carbon dioxide (CO₂) from a gas stream (e.g., a flue gas, a natural gas, a synthesis gas, a gas originating from a coal gasification, a coke oven gas, a refinery gas). A solid adsorbent can be used to adsorb CO₂ from a gas stream at a low temperature (e.g., about 20° C. to about 80° C.) to produce CO₂-enriched solid adsorbent and a clean gas stream. In some disclosed embodiments, a CO₂-enriched solid adsorbent can be efficiently recycled by heating it to a temperature of from about 100° C. to about 120° C. to strip away the adsorbed CO₂ to regenerate the original solid adsorbent. Presently disclosed solid adsorbents, methods, and systems desirably provide for maximizing CO₂ adsorption at a given temperature and to minimize adsorption at a regeneration temperature. Disclosed solid adsorbents include functional groups that have resulted in higher CO₂ uptake in comparison to existing solid adsorbents. Additionally, a disclosed solid adsorbent may include a narrow gap between a temperature used to efficiently adsorb CO₂ onto a solid adsorbent and a temperature to efficiently desorb CO₂ from the same solid adsorbent, which presents a significant commercial advantage over known technologies.

### Solid Adsorbents

According to some embodiments, a disclosed solid adsorbent includes an amine covalently linked to a polymer resin. A disclosed solid adsorbent may advantageously capture and release CO₂ from a gas stream with less energy cost than existing adsorbents. In some embodiments, an energy cost reduction may be due to the relatively small temperature differential between when the solid adsorbent adsorbs and desorbs CO₂. Additionally, disclosed solid adsorbents may efficiently desorb CO₂ at a lower temperature than known adsorbents, thereby decreasing costs (e.g., energy costs associated with heating) associated with practicing methods and systems for using these solid adsorbents. Some of the key factors that provide a disclosed solid adsorbent with this added benefit include having a resin with an optimal pore volume range, an optimal surface area range, an optimal porosity range, and an optimal covalently bound amine.

The invention further relates to a use of a polymer resin having an amine covalently bonded to said resin, as a solid adsorbent for capturing carbon dioxide (CO2) from a gas stream comprising CO2, wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.

In some embodiments, a disclosed solid adsorbent may be represented by, but is not limited to, Formula I below where n is a number of monomeric repeating units, and R is an amine. In some embodiments, R includes a hydrogen atom, an alkyl amine, an alkynyl amine, an alkenyl amine, an aryl amine, a straight chain alkyl amine, and a branched chain alkyl amine. An alkyl amine including any listed above may include one or more methylene spacers in between each nitrogen atom, such as from about 1 methylene to about 12 methylenes (C1-C12).

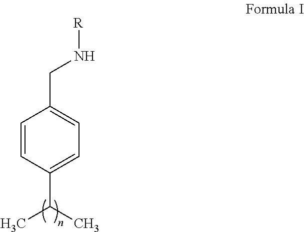

An advantage of the present invention is that the length of the R group is substantially constant. With constant is meant that per batch of adsorbent manufactured, the R group is substantially of the same length. Further also between batches manufactured the length of the R group can be reproduced. This allows for providing batches of adsorbents with the same characteristics preventing adsorbent processes of requiring of requiring extensive readjustments after replacing one batch of adsorbents according to the invention with another batch of adsorbents according to the invention.

In an embodiment at least 95% of the R group have the same length and preferably at least 99% of the R groups have the same length.

In an embodiment the adsorbent has as a functional group R, an alkyl amine and wherein the length of the alkyl amine is for at least for 95% the same and more preferably the alkyl amine is selected from the group consisting of ethylene amine, propylene amine or butylene amine. Preferably at least 99% of the functional groups are of the same length.

With 99% same length is meant that in case ethylene amine is selected at least 99% of the functional group are ethylene amine.

In case R is an alkylene amine, it means that an alkylene diamine is covalently bonded to the resin. For example, if R is an ethylene amine, the amine covalently bonded to the resin is an ethylene diamine.

A disclosed solid adsorbent may include any number of amines covalently bonded to any number of polymer resin units (collectively a polymer resin).

A disclosed amine may be covalently bonded to a polymer resin. An amine includes any number of amines (e.g., primary, secondary, tertiary) including benzylamine, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,3-diaminopentane, 1,2-diaminopropane, and combinations thereof. Therefore, in some embodiments, R may include alkyl amines, aryl amines, alkyl diamines, aryl diamines, alkyl triamines, aryl triamines, primary amines, secondary amines, tertiary amines, and combinations thereof. Preferably the amine is selected from the group consisting of ethylenediamine, 1,3-diaminopropane, 1,4-diaminobutane. An amine component of a solid adsorbent is not limited to the amines listed. For example, a disclosed solid adsorbent may include a diamine having from one to ten methylene units separating the amines. Additionally, an amine of a disclosed solid adsorbent may include from one to ten amines. A solid adsorbent may include a polymer resin covalently linked to an alkyl amine having one amine, or two amines, or three amines, or four amines, or five amines, or six amines, or seven amines, or eight amines, or nine amines, or ten amines. For example, a disclosed solid adsorbent may include a polymer resin covalently linked to an ethylenediamine. Based on the amount of bound amine, a solid adsorbent may have varying dry nitrogen contents.

In some embodiments, a solid adsorbent may have a dry nitrogen content from about 1 mol/kg to about 30 mol/kg. For example, a solid adsorbent may have a dry nitrogen content of about 1 mol/kg, or about 5 mol/kg, or about 10 mol/kg, or about 15 mol/kg, or about 20 mol/kg, or about 25 mol/kg, or about 30 mol/kg, where about includes plus or minus 5 mol/kg.

A solid adsorbent may include a polymer resin of any general size. For example, a solid adsorbent may include a polymer resin having an n value from 2-10,000, or larger. In some embodiments, a solid adsorbent includes a polymer resin having an n value of 2, or about 25, or about 50, or about 75, or about 100, or about 250, or about 500, or about 1,000, or about 2,000, or about 3,000, or about 4,000, or about 5,000, or about 6,000, or about 7,000, or about 8,000, or about 9,000, or about 10,000, where about includes plus or minus 500. In some embodiments a polymer resin may be a polystyrene.

A disclosed polymer resin may be cross-linked with various amounts of a cross-linking agent (e.g., divinylbenzene (DVB), methylene bisacrylamide, ethylene glycol dimethacrylate, N-(1-Hydroxy-2,2-dimethoxyethyl)acrylamide), which may alter one or more physical characteristics of the polymer resin including pore volume, surface area, and porosity. Alterations (e.g., increase, decrease) to at least one of pore volume, surface area, and porosity of a polymer resin may alter (e.g., increase, decrease) the CO₂ adsorption capabilities of a solid adsorbent. In some embodiments, a solid adsorbent includes a polymer resin (e.g., a polystyrene) that has been cross-linked with from about 4% to about 10% DVB, by weight of the polymer. Disclosed polymer resins having a DVB cross-linking from about 4% to about 10% (e.g., ˜5.5%) may have superior mechanical and swelling properties, in comparison to polymer resins having lower DVB cross-linking (e.g., ˜1%-2%) that promote desirable CO₂ adsorption and desorption at advantageous temperatures. For example, disclosed resins cross-linked with from about 4% to about 10% DVB provide for desirable pore volume, surface area, and porosity, which all synergistically promote high CO₂ adsorption rates at temperatures from about 40° C. to about 60° C. and higher desorption rates at temperatures from about 100° C. to about 120° C., in comparison to existing polymer resins. Additionally, having desirable pore volume, surface area, and porosity, may also synergistically provide for a solid adsorbent that has a CO₂ uptake capacity of greater than about 7 wt. % at a temperature of about 40° C., and wherein the solid adsorbent has a CO₂ uptake capacity of less than about 1.5 wt. % at a temperature of about 100° C. In some embodiments, having desirable pore volume, surface area, and porosity, may also synergistically provide for a solid adsorbent that has a CO₂ uptake capacity of greater than about 0.07 g/g solid adsorbent at a temperature of about 40° C., and wherein the solid adsorbent has a CO₂ uptake capacity of less than about 0.015 g/g solid adsorbent at a temperature of about 100° C. In some embodiments, a disclosed polymer resin can be cross-linked with about 4% DVB, or about 6% DVB, or about 8% DVB, or about 10% DVB, where about includes plus or minus 1 DVB, by weight of the polymer resin.

According to some embodiments, a polymer resin may have a pore volume from about 0.001 cm³/g to about 0.5 cm³/g. For example, a disclosed polymer resin may have a pore volume of about 0.001 cm³/g, or about 0.01 cm³/g, or about 0.05 cm³/g, or about 0.1 cm³/g, or about 0.5 cm³/g, where about includes plus or minus 0.1 cm³/g. Having a polymer resin with a relatively high pore volume relative to existing polymer resins desirably permits enhanced diffusion of the gas and thus CO₂ into the polymer resin. Disclosed polymer resins with enhanced diffusion may advantageously provide for higher CO₂ adsorption rates at temperatures from about 40° C. to about 60° C. and higher desorption rates at temperatures from about 100° C. to about 120° C., in comparison to existing polymer resins. Having a polymer resin with a relatively high pore volume relative to existing polymer resins may also synergistically provide for a solid adsorbent that has a CO₂ uptake capacity of greater than about 7 wt. % at a temperature of about 40° C., and where the solid adsorbent has a CO₂ uptake capacity of less than about 1.5 wt. % at a temperature of about 100° C. In some embodiments, having a polymer resin with a relatively high pore volume relative to existing polymer resins may also synergistically provide for a solid adsorbent that has a CO₂ uptake capacity of greater than about 0.07 g/g solid adsorbent at a temperature of about 40° C., and where the solid adsorbent has a CO₂ uptake capacity of less than about 0.015 g/g solid adsorbent at a temperature of about 100° C.

In some embodiments, a polymer resin may have a porosity ranging from about 10% to about 99%. Porosity, or percent of the volume of voids over the total volume of the resin, can directly relate to a polymer resin having high or low diffusion of CO₂ throughout the polymer resin. For example, a disclosed polymer resin having a porosity of 50% or greater may advantageously have a high diffusion so that CO₂ may readily infiltrate and adsorb onto the polymer resin or an amine covalently linked to the polymer resin. A disclosed polymer resin may have a porosity of greater than about 10%, or greater than about 20%, or greater than about 30%, or greater than about 40%, or greater than about 50%, or greater than about 60%, or greater than about 70%, or greater than about 80%, or greater than about 90%, or greater than about 99%, where about includes plus or minus 5%. A disclosed polymer resin may have a higher porosity with respect to known polymer resins, thereby promoting higher CO₂ adsorption rates at temperatures from about 40 to about 60° C. and higher desorption rates at temperatures from about 100° C. to about 120° C., in comparison to existing polymer resins. A disclosed polymer having a higher porosity with respect to known polymer resins may also synergistically provide for a solid adsorbent that has a CO₂ uptake capacity of greater than about 7 wt. % at a temperature of about 40° C., and wherein the solid adsorbent has a CO₂ uptake capacity of less than about 1.5 wt. % at a temperature of about 100° C. In some embodiments, a disclosed polymer having a higher porosity with respect to known polymer resins may also synergistically provide for a solid adsorbent that has a CO₂ uptake capacity of greater than about 0.07 g/g solid adsorbent at a temperature of about 40° C., and wherein the solid adsorbent has a CO₂ uptake capacity of less than about 0.015 g/g solid adsorbent at a temperature of about 100° C. Disclosed polymer resins, according to some embodiments, may include surface area from about 1 to about 60 m²/g. Disclosed polymer resins having a higher surface area in comparison to known polymer resins may have a higher comparative CO₂ uptake (wt. % or g/g solid adsorbent). A higher surface area may permit more CO₂ to polymer resin surface contact. A disclosed polymer may have a higher surface area relative to known polymer resins when compared similar weights of the comparative polymer resins. A disclosed polymer resin may have a surface area of about 1 m²/g, or about 10 m²/g, or about 20 m²/g, or about 30 m²/g, or about 40 m²/g, or about 50 m²/g, or about 60, where about includes plus or minus 5 m²/g. In some embodiments, a disclosed polymer having a higher surface area may provide for higher CO₂ adsorption rates at temperatures from about 40° C. to about 60° C. and higher desorption rates at temperatures from about 100° C. to about 120° C., in comparison to existing polymer resins. A disclosed polymer having a higher surface area with respect to known polymer resins may synergistically provide for a solid adsorbent that has a CO₂ uptake capacity of greater than about 7 wt. % at a temperature of about 40° C., and wherein the solid adsorbent has a CO₂ uptake capacity of less than about 1.5 wt. % at a temperature of about 100° C. In some embodiments, a disclosed polymer having a higher surface area with respect to known polymer resins may synergistically provide for a solid adsorbent that has a CO₂ uptake capacity of greater than about 0.07 g/g solid adsorbent at a temperature of about 40° C., and wherein the solid adsorbent has a CO₂ uptake capacity of less than about 0.015 g/g solid adsorbent at a temperature of about 100° C.

In some embodiments, a disclosed solid adsorbent includes a polymer resin having a pore diameter from about 1 nm to about 10 nm. For example, a polymer resin may have a pore diameter of about 1 nm, or about 2 nm, or about 3 nm, or about 4 nm, or about 5 nm, or about 6 nm, or about 7 nm, or about 8 nm, or about 9 nm, or about 10 nm, where about includes plus or minus about 0.5 nm. Having a higher pore diameter may desirably promote a gas stream having CO₂ to readily access surfaces of a solid adsorbent so that it can more easily adsorb CO₂ from the gas stream. In disclosed embodiments, having a pore diameter from about 1 nm to about 10 nm may synergistically function with other disclosed features to promote a high CO₂ uptake capacity at temperatures of about 40° C. and a low uptake capacity at temperatures of about 100° C.

In some embodiments, a solid adsorbent includes a polymer resin having a nitrogen to carbon ratio from about 0.05 to about 0.25. For example, a polymer resin may have a nitrogen to carbon ratio of about 0.05, or about 0.10, or about 0.15, or about 0.20, or about 0.25, where about includes plus or minus 0.025. Having a nitrogen to carbon ratio from about 0.05 to about 0.25 may desirably provide for a high CO₂ uptake capacity at temperatures of about 40° C. and a low uptake capacity at temperatures of about 100° C. A polymer resin may also have a weight of nitrogen from about 5 to about 20 wt. %, by weight of the polymer resin on a dry basis. For example, a polymer resin may have a weight of nitrogen of about 5 wt. %, or about 7.5 wt. %, or about 10 wt. %, or about 12.5 wt. %, or about 15 wt. %, or about 7.5 wt. %, or about 7.5 wt. %, where about includes plus or minus 1.25 wt. %, by weight of the polymer resin on a dry basis. In some embodiments, a polymer resin may also have a weight of nitrogen from about 0.05 g/g of polymer resin to about 0.20 g/g of polymer resin, by weight of the polymer resin on a dry basis. For example, a polymer resin may have a weight of nitrogen of about 0.05 g/g of polymer resin, or about 0.075 g/g of polymer resin, or about 0.10 g/g of polymer resin, or about 0.125 g/g of polymer resin, or about 15 g/g of polymer resin, or about 0.175 g/g of polymer resin, or about 0.2 g/g of polymer resin, where about includes plus or minus 0.0125 g/g of polymer resin, by weight of the polymer resin on a dry basis.

A polymer resin, according to some embodiments, can have an average particle diameter ranging from about 100 μm to about 1,000 μm. A polymer resin may have an average particle diameter of about 100 μm, or about 200 μm, or about 300 μm, or about 400 μm, or about 500 μm, or about 600 μm, or about 700 μm, or about 800 μm, or about 900 μm, or about 1,000 μm, where about includes plus or minus 50 μm.

According to some embodiments, a disclosed polymer resin can have a mesh size from about 10 to about 500. For example, a disclosed polymer resin may include a mesh size of about 10, or about 25, or about 50, or about 100, or about 125, or about 150, or about 175, or about 200, or about 125, or about 150, or about 175, or about 200, or about 225, or about 250, or about 275, or about 300, or about 325, or about 350, or about 375, or about 400, or about 425, or about 450, or about 475, or about 500, where about includes plus or minus 12.5. Having a larger mesh size may desirably provide for a larger surface area.

In some embodiments, the present disclosure relates to a disclosed solid adsorbent for capturing CO₂ from a gas stream comprising CO₂, the solid adsorbent including an amine covalently bonded to a polymer resin, a polymer resin having a pore volume from about 0.001 cm³/g to about 0.01 cm³/g, a surface area from about 1 m²/g to about 60 m²/g, a polystyrene polymer resin, a porosity from about 45% to about 55%, a dry nitrogen content from about 5 mol/kg to about 10 mol/kg, and a dry nitrogen content of greater than about 10 wt. % (0.1 g/g solid adsorbent), by weight of the solid adsorbent, at a temperature of about 40° C., by weight of the solid adsorbent.

An embodiment of the invention relates to a method for preparing a solid adsorbent for capturing carbon dioxide (CO2) from a gas stream comprising CO2. The method comprises the step of combining an amine with a chloromethylated polymer resin to form the solid adsorbent The obtained solid adsorbent has a dry nitrogen content from about 5 mol/kg to about 10 mol/kg, wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream. In a preferred embodiment the amine is a diamine.

In the step of combining the amine and the chloromethylated polymer resin the amine is present in at least stochiometric amounts compared to the chloromethylated groups of the polymer resin. The advantage of the current method is that by linking the amine compounds to the polymer resin in this way, the variation of the length of the functional groups linked to the resin is the same as the variation of the amine used. This means that if a commercially available amine is used, the variation in length of linked amine groups is substantially the same as for the commercially amine used. Typically, commercially available amines have a purity of 99%. In case an amine of such purity is used the percentage of functional groups will having the same length is also 99%.

One or more embodiments relating to the solid sorbent and/or the use of the resin having an amine covalently bonded thereto may be combined.

### CO₂ Adsorption Systems

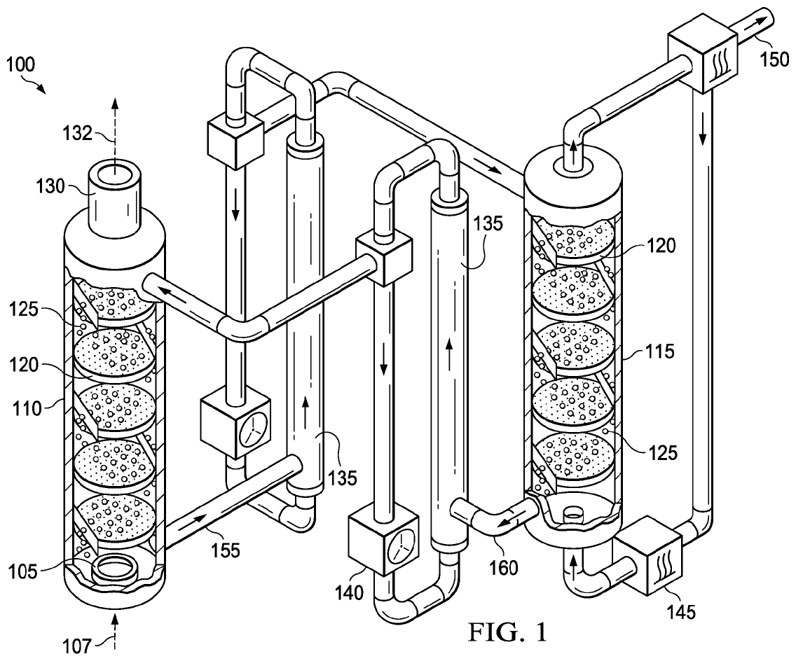

As shown in FIG. 1, the present disclosure relates, according to some embodiments, to a system 100 for capturing CO₂ from a gas stream 107 including CO₂. A system 100 may include an adsorption zone 110 having a solid adsorbent configured to adsorb CO₂ from a gas stream 107 and generate a CO₂-enriched solid adsorbent. System 100 may further include a desorption zone 115 configured to desorb CO₂ from a CO₂-enriched solid adsorbent produced by the adsorption zone 110. An adsorption zone 110 may be connected (e.g., directly, indirectly) to a desorption zone 115 for example through one or more of a transfer line and a recycle line. As shown in FIG. 1, a transfer line 155 may permit the transfer of one or more of a solid adsorbent, a fluid, and a gas from a bottom of an adsorption zone 110 to riser 135 that continues the transfer to a top of desorption zone 115. A recycle line 160 permits a solid adsorbent to be transferred from a bottom of a desorption zone 115 to a riser 135 that continues the transfer to a top of an adsorption zone 110.

As illustrated in FIG. 1, a system 100 may include an adsorption zone 110 configured to receive a gas stream 107 (e.g., a flue gas) through a gas inlet 105. An adsorption zone 110 includes one or more solid adsorbent beds 120 that support a solid adsorbent 125 as it is contacted with a received gas containing CO₂ at a temperature from about 20° C. to about 80° C. An adsorption zone 110 may be heated by any known means including steam, heating coils, thermocouples, external heating, and combinations thereof. In some embodiments, since CO₂ adsorption may be an exothermic reaction, no heat input may be required. According to some embodiments, an adsorption zone may be cooled by any known means including fluid cooling (e.g., water cooling), gas cooling (e.g., air cooling), and combinations thereof. While contacting a gas containing CO₂, the CO₂ may be adsorbed onto a solid adsorbent 125, thereby producing a CO₂ lean flue gas 132 and a CO₂-enriched solid adsorbent. A CO₂ lean flue gas 132 may have a CO₂ content of less than about 2%, by weight of the CO₂ lean flue gas 132. For example, a CO₂ lean flue gas 132 may have a CO₂ content of less than about 2%, or less than about 1.8%, or less than about 1.6%, or less than about 1.4%, or less than about 1.2%, or less than about 1%, or less than about 0.8%, or less than about 0.7%, or less than about 0.6%, or less than about 0.5%, or less than about 0.4%, or less than about 0.3%, or less than about 0.2%, or less than about 0.1%, where about includes plus or minus 0.05%, by weight of the CO₂ lean flue gas 132. At a top of an adsorption zone 110 is a CO₂ lean gas outlet 130 where the CO₂ lean gas outlet 130 can leave the system 100 to be collected by any number of gas tanks and compressors or may be released into the environment.

In some embodiments, an adsorption zone 110 can have any number of solid adsorbent beds 120 as required for desirable CO₂ lean gas 132 outputs. For example, an adsorption zone 110 can have from one to ten solid adsorbent beds 120. As shown in FIG. 1, an adsorption zone 110 can have five solid adsorbent beds 120, but the adsorption zone 110 can also have one solid adsorbent bed 120, or two solid adsorbent beds 120, or three solid adsorbent beds 120, or four solid adsorbent beds 120, or six solid adsorbent beds 120, or seven solid adsorbent beds 120, or eight solid adsorbent beds 120, or nine solid adsorbent beds 120, or ten solid adsorbent beds 120. In some embodiments, solid adsorbent beds 120 are arranged in a horizontal plane and are stacked vertically throughout an interior of an adsorption zone 110. In an adsorption zone 110 having more than one solid adsorbent bed 120, solid adsorbent 125 particles may flow from a top solid adsorbent bed down to any solid adsorbent bed 120 contained below until the solid adsorbent 125 particles leave the adsorption zone 110 as they are transported to a desorption zone 115. Flow from a higher up solid adsorbent bed 120 to a lower one may be driven by gravity, gas pressure, fluid pressure, and combinations thereof.

After a solid adsorbent 125 contained in an adsorption zone 110 becomes a CO₂-enriched solid adsorbent, it may be transferred to a riser 135 by being pushed by gas pressure provided by gas blower 140. A riser 135 includes a mechanical rotary device that transports solid adsorbent from one position to another in a disclosed system 100. Gas provided by a gas blower 140 includes any compressible gas such as argon, nitrogen, helium, air, oxygen, CO₂, a lean flue gas, and combinations thereof. A riser 135 may receive a CO₂-enriched solid adsorbent received from a bottom of an adsorption zone 110, through a transfer line 155, so that it can be transferred by the riser 135 to a top of a desorption zone 115.

In some embodiments, once a CO₂-enriched solid adsorbent has been transferred to a desorption zone 115, thermal energy received from steam produced by a steam generator 145 may induce desorption of a CO₂ from the CO₂-enriched solid adsorbent to produce a CO₂-depleted solid adsorbent and an isolated CO₂ that can leave a system 100 through a CO₂ gas outlet 150 to be collected by any number of tanks and compressors. A steam generator 145 may heat a CO₂-enriched solid adsorbent contained in a desorption zone 115 to a temperature from about 100° C. to about 120° C., which causes CO₂ desorption from the CO₂-enriched solid adsorbent.

Similar to an adsorption zone 110, a desorption zone 115 may have any number of solid adsorbent beds 120. For example, a desorption zone 115 can have from one to ten solid adsorbent beds 120. As shown in FIG. 1, a desorption zone 115 can have five solid adsorbent beds 120, but the desorption zone 115 can also have one solid adsorbent bed 120, or two solid adsorbent beds 120, or three solid adsorbent beds 120, or four solid adsorbent beds 120, or six solid adsorbent beds 120, or seven solid adsorbent beds 120, or eight solid adsorbent beds 120, or nine solid adsorbent beds 120, or ten solid adsorbent beds 120. Having a higher number of solid adsorbent beds may increase a capacity of a desorption zone 115 to contain solid adsorbent, whether it is CO₂-enriched or depleted.

According to some embodiments, once a CO₂-depleted solid adsorbent is generated in a desorption zone 115, it may be returned to an adsorption zone 110 so that it can be recycled. Initially, solid adsorbent 125 contained within a desorption zone 115 is transferred from a top of the desorption zone 115 to a bottom of the desorption zone 115 by pressure generated by gas produced by a gas blower 140. Once a solid adsorbent 125 is at a bottom of a desorption zone 115, it will be CO₂-depleted solid adsorbent that is transferred by a riser 135 to returned to a top of an adsorption zone 110, as shown in FIG. 1.

According to some embodiments, a disclosed system 100 may remove from about 5% to about 99.9% of CO₂ from a gas. A system 100 may remove greater than about 5%, or greater than about 10%, or greater than about 15%, or greater than about 20%, or greater than about 25%, or greater than about 30%, or greater than about 35%, or greater than about 40%, or greater than about 45%, or greater than about 50%, or greater than about 55%, or greater than about 60%, or greater than about 65%, or greater than about 70%, or greater than about 75%, or greater than about 80%, or greater than about 85%, or greater than about 90%, or greater than about 95%, or greater than about 99%, of a CO₂ from a gas, where about includes plus or minus 2.5%, by weight of the gas. Additionally, a disclosed system 100 may produce a gas having less than about 90% CO₂, or less than about 80% CO₂, or less than about 70% CO₂, or less than about 60% CO₂, or less than about 50% CO₂, or less than about 40% CO₂, or less than about 30% CO₂, or less than about 20% CO₂, or less than about 10% CO₂, or less than about 1% CO₂, where about includes plus or minus 5% CO₂, by weight of the gas. For example, a system 100 may produce a gas having 0.4% CO₂, by weight of the gas.

Besides the components described in FIG. 1, disclosed systems 100 may include additional components. For example, a system 100 may include a temperature reducer, a pre-regenerator, a first condensation accumulator, a second condensation accumulator, a preheater, and a CO₂-depleted solid adsorbent cooler.

In some embodiments, a system 100 includes a temperature reducer that cools off gas stream 107. A gas stream may be received at a temperature of about 40° C. to 50° C. and need to be cooled off to ensure proper adsorption once it reaches an adsorption zone 110. A temperature reducer may include cooling heat exchangers that cool a gas stream 107 to a temperature of about 30° C. Since cooling may create condensation, a temperature reducer may include a first condensation accumulator that sequesters condensation created by a quench cooler.

In some embodiments, a system 100 may include a heat exchanger in between an adsorption zone 110 and a pre-regenerator so that a CO₂-enriched solid adsorbent can be heated to a temperature ranging from about 60° C. to about 100° C. A heat exchanger is connected to a bottom of an adsorption zone 110 through a connector. Additionally, a heat exchanger is connected to a top of a pre-regenerator through a connector. A disclosed heat exchanger acts as an intermediate station before a CO₂-enriched solid arrives at a pre-regenerator. A preheater may be heated by electric heating coils, steam, and combinations thereof.

According to some embodiments, a system 100 may include a pre-regenerator configured to heat a CO₂-enriched solid adsorbent can be heated to a temperature ranging from about 100° C. to about 120° C. Heat may be provided to a pre-regenerator from a steam generator 145. A pre-regenerator can have from one to ten solid adsorbent beds. For example, a pre-regenerator can have one solid adsorbent bed, or two solid adsorbent beds, or three solid adsorbent beds, or four solid adsorbent beds, or five adsorbent beds, or six solid adsorbent beds, or seven solid adsorbent beds, or eight solid adsorbent beds, or nine solid adsorbent beds, or ten solid adsorbent beds. A pre-regenerator may connect to a top of a desorption zone 115 through a connector. A pre-regenerator may transfer at least a portion of a CO₂-enriched solid adsorbent contained within the pre-regenerator to a desorption zone 115 through a connector so that the CO₂ desorption process can continue.

A Desorption zone 115 may operate similarly and contain similar components as one shown in FIG. 1. However, in some embodiments, in between a desorption zone 115 and an adsorption zone 110, a CO₂-depleted solid adsorbent cooler may intercept a CO₂-depleted solid adsorbent as it is transferred from the desorption zone 115 to the adsorption zone 110. A CO₂-depleted solid adsorbent cooler uses a heat exchanger to reduce a temperature of the CO₂-depleted solid adsorbent cooler to a range from about 40° C. to about 110° C., allowing it to be recycled and to efficiently adsorb CO₂ from a gas again. A desorption zone 115, an adsorption zone 110, and a CO₂-depleted solid adsorbent cooler may each be interconnected through a series of connectors.

According to some embodiments, as CO₂ is released through desorption in a preheater, a pre-regenerator, and a desorption zone 115, it may be collected by a CO₂ compressor that connects to each component through connectors. A CO₂ compressor can receive, compress, and store released CO₂.

In some embodiments, a disclosed system 100 may operate under substantially dry conditions. For example, a disclosed system 100 may be substantially anhydrous. However, a system 100 may operate under conditions that permit some water, such as that contained in a solvent and in a gas stream comprising CO₂ and some water.

### CO₂ Adsorption Processes

In some embodiments, the present disclosure relates to processes for capturing CO₂ from a gas stream comprising CO₂ (e.g., a flue gas) using the above-described systems and solid adsorbents. A disclosed process includes contacting a gas stream with a solid adsorbent in an adsorption zone to form a CO₂-enriched solid adsorbent and a CO₂ lean flue gas. In some embodiments, a CO₂ lean flue gas may have a CO₂ content of less than about 2%, by weight of the CO₂ lean flue gas. Disclosed processes may be adjusted to target specific production of CO₂ lean flue gases having specific CO₂ compositions. For example, a process may be adjusted to produce a CO₂ lean flue gas having a CO₂ content of less than about 2%, or less than about 1.8%, or less than about 1.6%, or less than about 1.4%, or less than about 1.2%, or less than about 1%, or less than about 0.8%, or less than about 0.7%, or less than about 0.6%, or less than about 0.5%, or less than about 0.4%, or less than about 0.3%, or less than about 0.2%, or less than about 0.1%, where about includes plus or minus 0.05%, by weight of the CO₂ lean flue gas. For example, a disclosed process may absorb from about 80% to about 100% of CO₂ from a gas stream containing from about 400 ppm to about 30 vol. % CO₂, which may result in a lean flue gas having a CO₂ content of less than about 2%.

A process may include use of a solid adsorbent having an amine covalently bonded to a polymer resin (e.g., a polystyrene). As described above, a solid adsorbent composition may be adjusted to provide for a desired CO₂ lean flue gas outcome. In some embodiments, a process may include heating a portion of a CO₂-enriched solid adsorbent in a desorption zone to a temperature from about 90° C. to about 120° C., to desorb at least a portion of a CO₂ from the CO₂-enriched solid adsorbent to form a desorbed CO₂ and a CO₂-depleted solid adsorbent. For example, a CO₂-enriched solid adsorbent can be heated in a desorption zone to a temperature of about 90° C., or about 100° C., or about 110° C., or about 120° C., where about includes plus or minus 5° C. Additionally, a CO₂-enriched solid adsorbent may be heated at a temperature to desorb at least 10% of the adsorbed CO₂, or at least about 20% of the adsorbed CO₂, or at least about 30% of the adsorbed CO₂, or at least about 40% of the adsorbed CO₂, or at least about 50% of the adsorbed CO₂, or at least about 60% of the adsorbed CO₂, or at least about 70% of the adsorbed CO₂, or at least about 80% of the adsorbed CO₂, or at least about 90% of the adsorbed CO₂, or at least about 99% of the adsorbed CO₂, where about includes plus or minus 5%

If one desorption zone is not adequate for a complete or substantially complete desorption, a process may include a step of heating a portion of a CO₂-enriched solid adsorbent in a pre-regenerator, to a temperature from about 90° C. to about 120° C., before heating the CO₂-enriched solid adsorbent in a desorption zone. Additionally, a process may include heating a portion of a CO₂-enriched solid adsorbent in a preheater to a temperature from about 60° C. to about 100° C., before heating the CO₂-enriched solid adsorbent in a pre-regenerator. Including additional heating units as described above may desirably provide for a more complete desorption of CO₂ from a CO₂-enriched solid adsorbent.

According to some embodiments, a disclosed process may include recycling a solid adsorbent that has had the CO₂ desorbed from it. For example, a process may include a step of recycling a CO₂-depleted solid adsorbent by transferring the CO₂-depleted solid adsorbent from a desorption zone to an adsorption zone. Once a solid adsorbent has been depleted of adsorbed CO₂, it is then free to re-adsorb CO₂ from a gas. Recycling may involve cooling a solid adsorbent to a temperature from about 40° C. to about 110° C., and then placing it into a top of an adsorption zone by using a riser.

Additionally, the present disclosure relates to a process for using a solid adsorbent for capturing CO₂ from a gas stream as well as systems for running the process.

One or more of the above embodiments relating to the system may be combined.

The appended claims and their dependencies form an integral part of the description by way of this reference.

### EXAMPLES

The following examples illustrate some specific example embodiments of the present. These examples represent specific approaches found to function well in the practice of the application, and thus can be considered to constitute examples of modes for its practice. However, those of skill in the art should, in light of the present disclosure, appreciate that many changes can be made in the specific embodiments that are disclosed without departing from the spirit and scope of the application.

### Example 1

A solid adsorbent for capturing CO₂ can be synthesized in many different ways. Many processes include combining a polymer resin with a diamine in a solvent. One example is shown below. A 100 mL round-bottom flask was charged with 20 ml of EDA. 1 g of a Merrifield resin was combined with the ethylene diamine and a magnetic stirrer within the round-bottom flask. The mixture was stirred at 300 rpm and heated to 50° C. overnight (approx. 18 hours). After mixing was complete, the mixture was allowed to cool to room temperature while continuing to stir at 300 rpm. After reaching room temperature, the mixture was filtered with a Buchner funnel equipped with a black label filter. After the resin was filtered, it was washed on the Buchner funnel with deionized water and methanol. The water and methanol washings were alternated until the resin became a slightly lighter colour. Roughly 300 ml of methanol and 300 ml of deionized water were used. After washing, the resin was left to dry at room temperature at about 1 ATM under a hood for six hours. After this initial drying, the resin was dried in the vacuum oven for about 20 hour at 70° C., at 200 mbar, with small amounts of nitrogen gas flow. The oven was flushed with nitrogen gas for at least one hour in advance to remove all the air from the oven. After this step, the resin was taken out of the oven and was stored in a 10 mL glass bottle. The resulting resin is an example of a disclosed solid adsorbent.

### Example 2

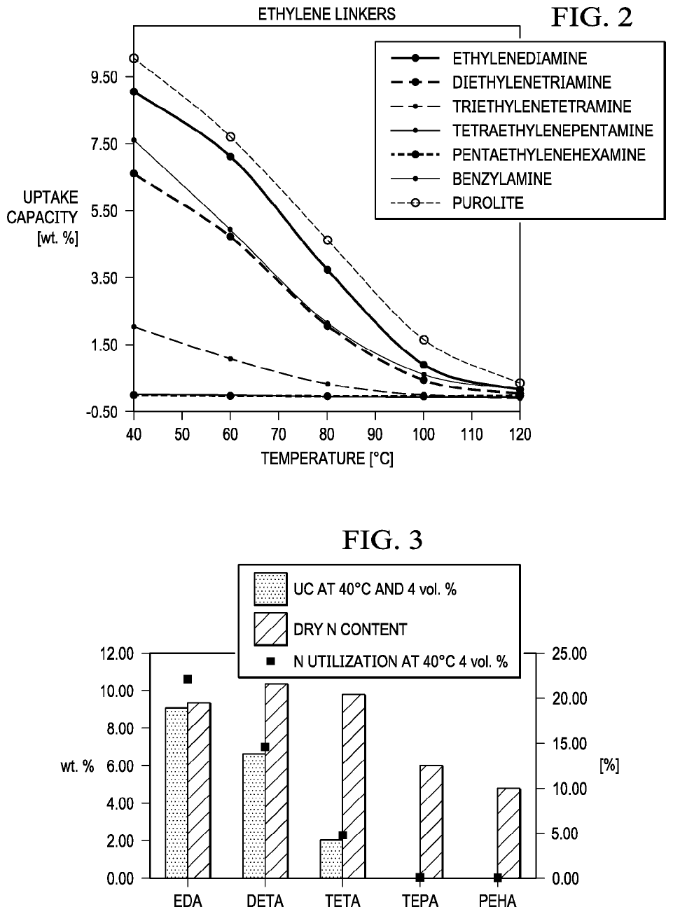

FIG. 2 shows an exemplary plot of the carbon dioxide uptake capacity vs temperature for selected solid adsorbents that were generated by covalently bonding an amine to a polystyrene resin, with the amines being various ethylene linkers. Specifically, the plot compares seven disclosed solid adsorbents that were prepared to be functionalized with one of ethylenediamine (EDA), diethylenetriamine (DETA), triethylenetetramine (TETA), tetraethylenepentamine (TEPA), pentaethylenehexamine (PEHA), or benzylamine. In this plot, a feed gas was used that contained 4 vol. % CO₂ and the analysis was performed by a Thermogravimetric Analyzer (TGA).

As shown in FIG. 2, at a temperature of about 40° C., the order of CO₂ uptake capacity (wt. % by weight of the solid adsorbent) of the tested solid adsorbents, from highest to lowest, is the solid adsorbent having the following covalently bonded amine: EDA, benzylamine, DETA, and then TETA. The solid adsorbents having TEPA and PEHA as their amine did not having an appreciable CO₂ uptake capacity. Additionally, as shown in FIG. 2, the CO₂ uptake capacity reduces to less than about 1.5 wt. % for all solid adsorbents once the temperature raises to above about 110° C.

### Example 3

FIG. 3 compares the CO₂ uptake capacity and nitrogen utilization at 40° C. and 4 vol % and the dry nitrogen content for disclosed solid adsorbents having each of EDA, DETA, TETA, TEPA, and PEHA as their covalently bonded amine group. In this example, the solid adsorbents are reference by their amine group. As shown in FIG. 3, the order of CO₂ uptake capacity at 40° C. and 4 vol % (referenced as “UC at 40° C. and 4 vol %), from highest to lowest, is EDA, DETA, and TETA, with TEPA and PEHA not having measurable results. The dry nitrogen content shows a similar pattern with the dry nitrogen content going from highest to lowest: DETA, TETA, EDA, TEPA, and PEHA. Out of these disclosed samples, the EDA solid adsorbent had the highest nitrogen utilization followed by DETA, and TETA, and with TEPA and PEHA not providing measurable nitrogen utilization.

### Example 4

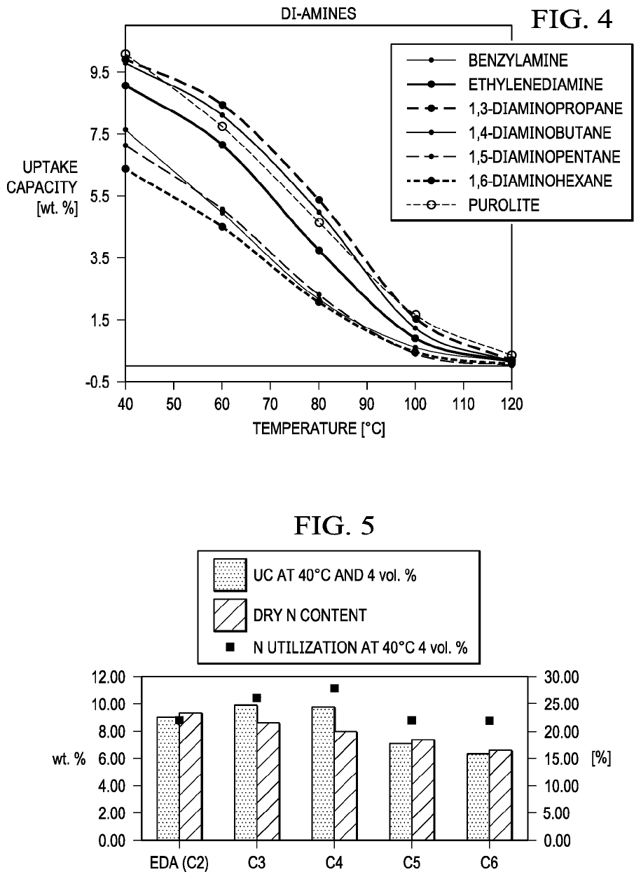

Five solid adsorbents were prepared using the methods outlined in Example 1, with the solid adsorbents being functionalized with various diamines including EDA (referenced as EDA), 1,3-diaminopropane (referenced as C3), 1,4-diaminobutane (referenced as C4), 1,5-diaminopentane (referenced as C5), and 1,6-diaminohexane (referenced as C6). These solid adsorbents were then tested for their CO₂ uptake capacity, their dry nitrogen content, and their nitrogen utilization. FIG. 4 shows an exemplary plot of the carbon dioxide uptake capacity vs temperature for solid adsorbents having various diamine linkers along with a solid adsorbent covalently bound to benzylamine as a comparison, according to a specific example embodiments of the disclosure. Specifically, the plot compares EDA, C3, C4, C5, C6, and benzylamine. As shown in FIG. 4, the order of CO₂ uptake capacity from highest to lowest at a temperature of 60° C. is C3, C4, EDA C5, benzylamine, and C6. Additionally, as shown in FIG. 4, the CO₂ uptake capacity reduces to less than about 1.5 wt. % for all solid adsorbents at a temperature of about 100° C.

### Example 5

FIG. 5 discloses the CO₂ uptake capacity at 40° C. and 4 vol %, the dry nitrogen content, and nitrogen utilization at 40° C. at 4 vol % for of the adsorbents from Examples 4. As shown in FIG. 5, the order of CO₂ uptake capacity at 40° C. and 4 vol %, from highest to lowest, is C4, C3, EDA, C5, and then C6. The order of dry nitrogen content from highest to lowest is EDA, C5, and then C6. All solid adsorbents displayed similar nitrogen utilization values.

### Example 6

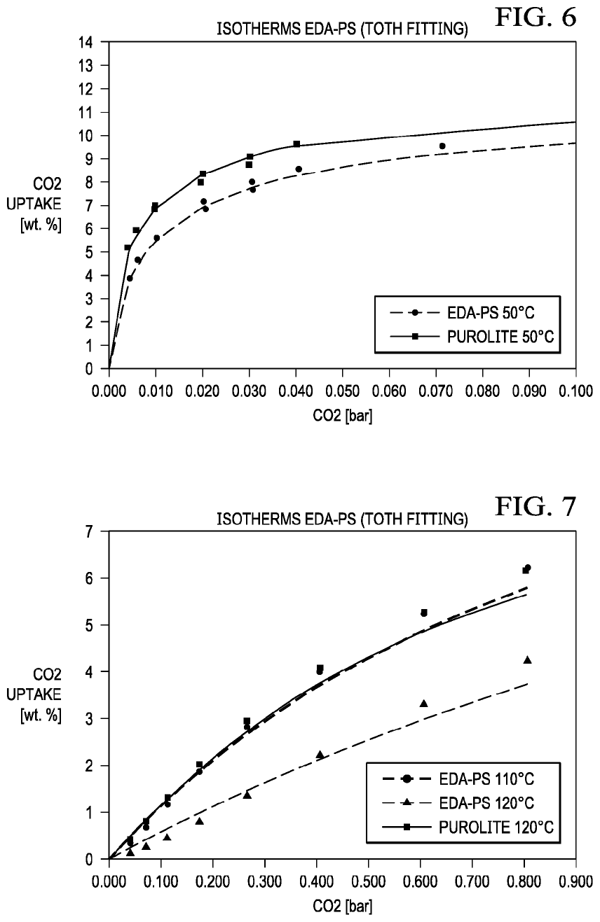

The CO₂ uptake capacities of polymer resins covalently bonded to EDA and Purolite A110 respectively were obtained at a single temperature of 50° C. (isotherm) across a range of CO₂ pressures ranging from 0 bar to 0.1 bar. As shown in FIG. 6, both samples readily adsorb CO₂ and saturate at about 12 wt. % or higher, by weight of the solid adsorbent.

Similarly, in FIG. 7, CO₂ uptake capacities of the EDA and Purolite A110 functionalized resins were measured at a higher temperature. Isotherm data was obtained for the EDA resin at temperatures of both 110° C. and 120° C., with isotherm data being obtained for the Purolite A110 resin at a temperature of 120° C. As shown in FIG. 7, a significant drop in CO₂ uptake is shown for the EDA resin when increasing the temperature from 110° C. to 120° C.

### Example 7

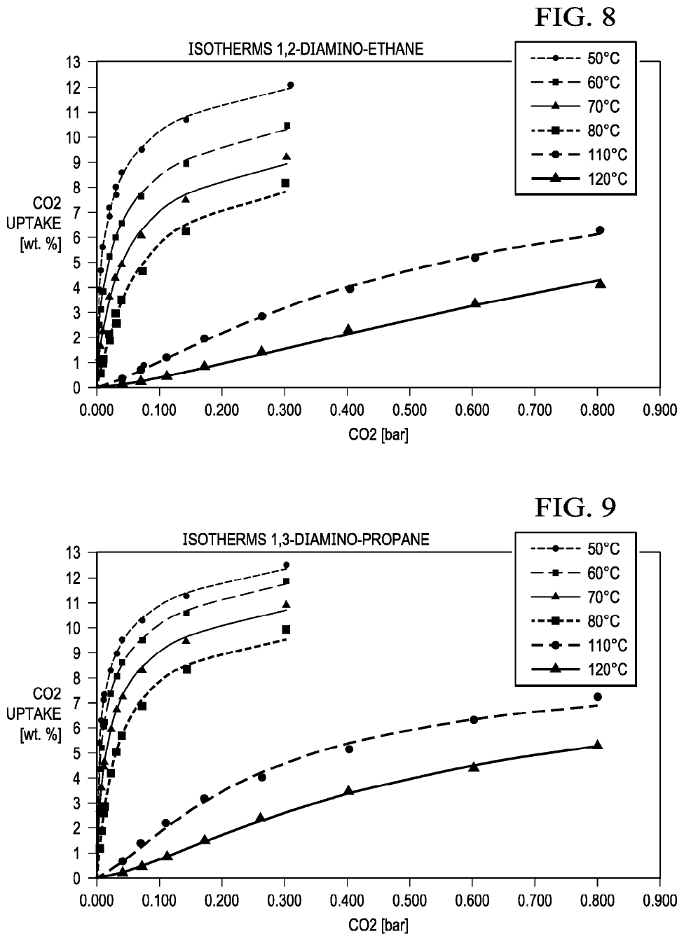

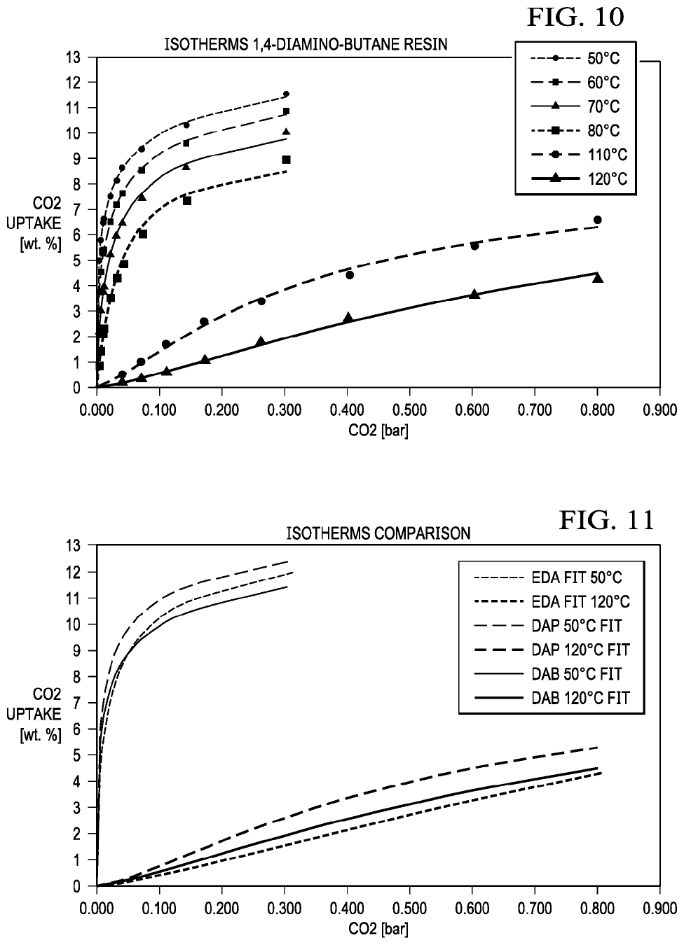

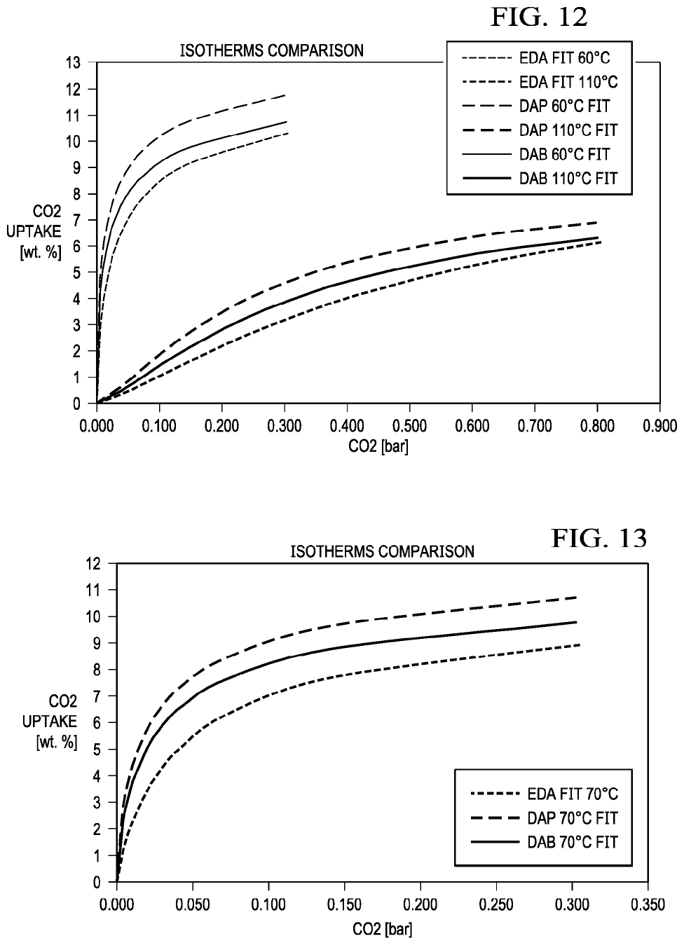

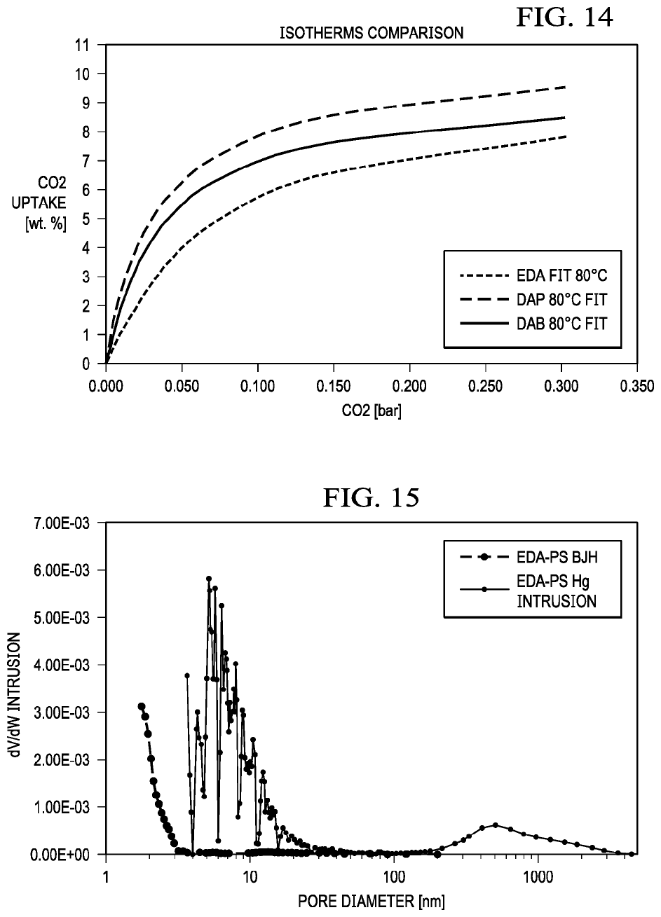

Isotherms of the resins disclosed in Example 4 were obtained. This data is shown in FIGS. 9-11. Specifically, the polymer resins covalently bonded to EDA (FIG. 8), 1,3-diaminopropane (C3) (FIG. 9), and 1,4-diaminobutane (C4) (FIG. 10) were obtained at temperatures including 50° C., 60° C., 70° C., 80° C., 110° C., and 120° C. Data obtained is plotted in other isomers as shown in FIGS. 11-14 that directly compare data from EDA, C3, and C4 at specific temperatures. At 50° C., the order of CO₂ uptake from highest to lowest is of C3>EDA>C4. At 60° C., the order of CO₂ uptake from highest to lowest is of C3>C4>EDA. At 70° C., the order of CO₂ uptake from highest to lowest is of C3>C4>EDA. At 80° C., the order of CO₂ uptake from highest to lowest is of C3>C4>EDA. At 110° C., the order of CO₂ uptake from highest to lowest is of C3>C4>EDA. At 120° C., the order of CO₂ uptake from highest to lowest is of C4>C3>EDA.

### Example 8

BET, mercury intrusion porosimetry (MIP), and elemental analyses were performed on various disclosed solid adsorbents. This data is shown in FIG. 15. As shown in FIG. 15, the MIP and BET and data is shown for EDA samples. BET is based on nitrogen physisorption and provides data that characterizes the surface area, pore volume, and pore diameter of a solid adsorbent. FIG. 15 shows the diameter distribution of an example of the material having micropores and macropores. The N/C ratio is an important property of the material.

### Example 9

In Table 1, CHN flash elemental analysis data shows the carbon, hydrogen, and nitrogen components of disclosed solid adsorbents.

TABLE 1
Elemental Analysis and Nitrogen Physisorption Data

| | | | N2 Physisorption | | | | | | | | |
|---|---|---|---|---|---|---|---|---|---|---|---|
| | | | | Single point | Adsorption | | | | | | |
| | | | | adsorption | av. pore | | | | | | |
| | | | BET | total pore | dia.(4V/A | CHN Flash | | | | UC at 40° C. | UC at 40° C. |
| | Sample | | surface | volume | by BET) | Carbon [% Hydrogen | | | | and 4 vol % | and 4 vol % |
| Source | ID | Amine | Area [m2/g] | [cm3/g] | [nm] | Nitrogen \| Sum [%] | | | | CO2 [wt %] | CO2 [mol/kg] |
| In-house | 286120 | Ethylenediamine | 6.7403 | 0.008766 | 4.6764 | 69.9 | 8.4 | 11.6 | 89.9 | 9.06 | 2.058938 |
| Resin | | (EDA) | | | | | | | | | |
| In-house | 286310 | Diethylenetriamine | 3.7757 | 0.005142 | 4.6167 | 72.7 | 8.8 | 13.7 | 95.2 | 6.62 | 1.50524 |
| Resin | | (DETA) | | | | | | | | | |
| In-house | 286278 | Triethylenetetramine | 4.9893 | 0.005639 | 3.6402 | 67.6 | 8.1 | 11.8 | 87.5 | 2.03 | 0.46227 |
| Resin | | (TETA) | | | | | | | | | |
| In-house | 286279 | Tetraethylenepentamine | 4.2596 | 0.0036 | 3.101 | 63.7 | 6.8 | 6.2 | 76.7 | 0.02 | 0.004522 |
| Resin | | (TEPA) | | | | | | | | | |
| In-house | 286280 | Pentaethylenehexamine | 5.8728 | 0.005013 | 3.1848 | 64.9 | 6.6 | 4.9 | 76.4 | 0 | 8.14 E−05 |
| Resin | | (PEHA) | | | | | | | | | |
| In-house | 286120 | Ethylenediamine | 6.7403 | 0.008766 | 4.6764 | 69.9 | 8.4 | 11.6 | 89.9 | 9.06 | 2.058938 |
| Resin | | (EDA) | | | | | | | | | |
| In-house | 286449 | 1,3 diaminopropane | | | | 69 | 9 | 10.5 | 88.5 | 9.9 | 2.249989 |
| Resin | | | | | | | | | | | |
| In-house | 286450 | 1,4-diaminobutane | | | | 68.3 | 8.8 | 9.5 | 86.6 | 9.79 | 2.223471 |
| Resin | | | | | | | | | | | |
| In-house | 286281 | 1,5-Diaminopentane | 5.5078 | 0.006124 | 3.8857 | 74.2 | 9.2 | 9.5 | 92.9 | 7.12 | 1.618799 |
| Resin | | | | | | | | | | | |
| In-house | 286283 | 1,6-Diaminohexane | 4.5861 | 0.005785 | 5.0456 | 71.1 | 9.1 | 8 | 88.2 | 6.36 | 1.445749 |
| Resin | | | | | | | | | | | |
| In-house | 286123 | Benzylamine | 7.9336 | 0.005924 | 2.1652 | 73.9 | 7.9 | 8.8 | 90.6 | 7.631965 | 1.734143 |
| Resin | | | | | | | | | | | |
| SPSS | Sigma | Ethylenediamine, | | | | | | | | 0.14 | 0.031811 |
| Resin | Aldrich | polymer-bound | | | | | | | | | |
| SPSS | TCI | N-(2- | | | | | | | | 0.1 | 0.022722 |
| Resin | | Aminoethyl)aminomethyl | | | | | | | | | |
| | | Polystyrene Resin | | | | | | | | | |
| | | cross-linked with 1% | | | | | | | | | |
| | | DVB (50-100 mesh) | | | | | | | | | |
| | | (3.1-3.5 mmol/g) | | | | | | | | | |
| SPSS | Sigma | StratoSpheres PL- | | | | | | | | 0.44 | 0.099977 |
| Resin | Aldrich | Deta | | | | | | | | | |
| | | (Diethylenetriamine) | | | | | | | | | |
| | | resin | | | | | | | | | |
| SPSS | Sigma | Diethylenetriamine, | | | | | | | | 0.69 | 0.156783 |
| Resin | Aldrich | polymer-bound | | | | | | | | | |
| Literature | 2015 | PS-EDA (3.7) | 525 | 0.83 | 9.3 | | | 3.73 | | 4.9 | 1.113383 |
| Resin | Bull | | | | | | | | | | |

It is understood that the listed apparatuses for each unit are for illustration purposes only, and this is not intended to limit the scope of the application. A specific combination of these or other apparatuses or units can be configured in such a system for the intended use based on the teachings in the application.

Persons skilled in the art may make various changes in the shape, size, number, separation characteristic, and/or arrangement of parts without departing from the scope of the instant disclosure. Each disclosed component, system, and process step may be performed in association with any other disclosed component, system, or process step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure. Where desired, some embodiments of the disclosure may be practiced to the exclusion of other embodiments.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value +/− about 10%, depicted value +/− about 50%, depicted value +/− about 100%) and/or a range endpoint. With respect to the former, a value of 50 depicted in an example, table, and/or drawing may form the basis of a range of, for example, about 45 to about 55, about 25 to about 100, and/or about 0 to about 100.

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

We claim:

1. A solid adsorbent for capturing carbon dioxide (CO2) from a gas stream comprising CO2, the solid adsorbent comprising an amine covalently bonded to a polymer resin,
wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.

2. The solid adsorbent according to claim 1, wherein at least one of:
the polymer resin comprises a pore volume from about 0.001 cm3/g to about 0.5 cm3/g;
the polymer resin comprises a surface area from about 1 m2/g to about 60 m2/g;
the polymer resin comprises polystyrene;
the polymer resin comprises a porosity from about 15% to about 60%.

3. The solid adsorbent according to claim 1, where at least one of:
the solid adsorbent comprises a dry nitrogen content from about 5 mol/kg to about 10 mol/kg.

4. The solid adsorbent according to claim 1, wherein the amine comprises at least one of a primary amine, a secondary amine, a benzylamine, an ethylenediamine, a diethylenetriamine, a tetraethylenepentamine, a pentaethylenehexamine, a triethylenetetramine, a 1,3-diaminopropane, a 1,4-diaminobutane, a 1,5-diaminopentane, a 1,6-diaminohexane, a 1,7-diaminoheptane, a 1,8-diaminooctane, a 1,9-diaminononane, a 1,10-diaminodecane, a 1,3-diaminopentane, a 1,2-diaminopropane, and combinations thereof.

5. The solid adsorbent according to claim 1 wherein the amine is an alkyl diamine and wherein the amine has a chain length and wherein the chain length of the alkyl amine covalently bonded to the resin is for at least for 95% the same.

6. A process for capturing carbon dioxide (CO2) from a gas stream comprising CO2, the process comprising:
(a) contacting the gas stream with a solid adsorbent in an adsorption zone to form a CO2-enriched solid adsorbent, wherein the solid adsorbent comprises an amine covalently bonded to a polymer resin; and
(b) heating a portion of the CO2-enriched solid adsorbent in a desorption zone to a temperature of greater than about 90° C. to desorb at least a portion of the CO2 from the CO2-enriched solid adsorbent to form a desorbed CO2 and a CO2-depleted solid adsorbent,
wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.

7. The process according to claim 6, further comprising transferring the CO2-enriched solid adsorbent from the adsorption zone to a pre-regenerator comprising heating coils; and
heating the CO2-enriched solid adsorbent in the pre-regenerator to a temperature of greater than about 90° C. to desorb an initial portion of the CO2 from the CO2-enriched solid adsorbent to form a partially CO2-depleted solid adsorbent.

8. The process according to claim 7, further comprising transferring the partially CO2-depleted solid adsorbent to the desorption zone; and
heating a portion of the partially CO2-depleted solid adsorbent in the desorption zone to a temperature of greater than about 90° C. to desorb an additional portion of the CO2 from the pre-regenerator treated solid adsorbent to form a second portion of the desorbed CO2 and a further CO2-depleted solid adsorbent.

9. The process according to claim 6, further comprising recycling the CO2-depleted solid adsorbent by transferring the CO2-depleted solid adsorbent from the desorption zone to the adsorption zone.

10. The process according to claim 8, further comprising recycling the further CO2-depleted solid adsorbent by transferring the CO2-depleted solid adsorbent from the desorption zone to the adsorption zone.

11. A system for capturing carbon dioxide (CO2) from a gas stream comprising CO2, the system comprising:
(a) an adsorption zone connected to a desorption zone through a transfer line and a recycle line, the adsorption zone comprising:
a gas stream inlet for receiving the gas stream;
a flue gas outlet for releasing a gas; and
at least one adsorbent bed comprising a solid adsorbent, wherein the solid adsorbent comprises an amine covalently bonded to a polystyrene resin,
wherein the adsorption zone is configured to receive the gas stream such that the gas stream contacts the solid adsorbent to form a CO2-enriched solid adsorbent,
wherein the desorption zone is configured to receive at least a portion of the CO2-enriched solid adsorbent from the adsorption zone through the transfer line and to heat a portion of the CO2-enriched solid adsorbent at a temperature of greater than about 90° C. to desorb at least a portion of the CO2 from the CO2-enriched solid adsorbent to form a desorbed CO2 and a CO2-depleted solid adsorbent,
wherein the recycle line is configured to transfer the CO2-depleted solid adsorbent from the desorption zone to the adsorption zone, and
wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.

12. The system of claim 11, wherein the adsorption zone comprises two or more solid adsorbent beds.

13. The system of claim 11, further comprising a pre-regenerator comprising heating coils, wherein the pre-regenerator is connected to the adsorption zone through a second transfer line and configured to receive at least a portion of the CO2-enriched solid adsorbent from the adsorption zone through the second transfer line, and wherein the pre-regenerator is configured to heat the portion of the CO2-enriched solid adsorbent to a temperature of greater than about 90° C. to form a partially CO2-depleted solid adsorbent

14. The system of claim 11, wherein the pre-regenerator is connected to the desorption zone through a third transfer line and is configured to transfer the partially CO2-depleted solid adsorbent to the desorption zone, wherein the desorption zone is configured to heat the partially CO2-depleted solid adsorbent to form a second portion of the desorbed CO2 and a further CO2-depleted solid adsorbent.

15. A method for preparing a solid adsorbent for capturing carbon dioxide (CO2) from a gas stream comprising CO2, the method comprising:
combining an amine with a chloromethylated polymer resin to form the solid adsorbent,
wherein the solid adsorbent comprises a dry nitrogen content from about 5 mol/kg to about 10 mol/kg, wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.

16. Use of a polymer resin having an amine covalently bonded thereto, as a solid adsorbent for capturing carbon dioxide (CO2) from a gas stream comprising CO2, wherein the solid adsorbent has a CO2 uptake capacity of greater than about 7 wt. % at a temperature of about 40° C., and wherein the solid adsorbent has a CO2 uptake capacity of less than about 1.5 wt. % at a temperature of about 100° C., as measured when the gas stream further comprises a concentration of the CO2 of about 4 vol. %, by volume of the gas stream.
